(19) United States
(12) Patent Application Publication
(10) Pub. No.: US 2019/0210854 A1
(43) Pub. Date: Jul. 11, 2019

(54) SYSTEM COMPRISING A CONTROL STATION AND A CONTROLLED DEVICE WITH IMPROVED OPERATING SAFETY

(71) Applicant: COMMISSARIAT A L'ENERGIE ATOMIQUE ET AUX ENERGIES ALTERNATIVES, Paris (FR)

(72) Inventors: Laurent ECK, Saint Lubin de la Haye (FR); Sabrina PANEELS, Thiais (FR); Margarita ANASTASSOVA, Nozay (FR); Florent SOUVESTRE, Orsay (FR); Ludovic LEMARCHAND, Oullins (FR); Andrew DELAHUNT, Lyon (FR)

(73) Assignee: COMMISSARIAT A L'ENERGIE ATOMIQUE ET AUX ENERGIES ALTERNATIVES, Paris (FR)

(21) Appl. No.: 16/334,566

(22) PCT Filed: Sep. 21, 2017
(86) PCT No.: PCT/FR2017/052538

§ 371 Date: Mar. 19, 2019

(30) Foreign Application Priority Data
Sep. 21, 2016 (FR) 16 58880

(51) Int. Cl. B66F 17/00; G05G 5/03; G05G 5/05; B66F 11/04

(52) U.S. Cl. CPC B66F 17/006; G05G 5/03; B66C 13/40; B66F 11/044; G05G 2505/00; G05G 5/05

(57) ABSTRACT

A system including a control station and at least one controlled device, the control station including at least one control device intended for controlling at least one action of the controlled device, the control device including a haptic interface including at least one element for interacting with the user, and a controller configured to send orders to the haptic interface to generate haptic stimulations in the element for interacting with the user on the basis at least of information relative to a state of the controlled device and/or the environment thereof.

### TECHNICAL FIELD AND STATE OF PRIOR ART

The present invention relates to a system including a control station and at least one controlled device, controlled by said control station, offering an improved operating safety.

One example of such systems is the mobile elevating work platforms (also designated by the acronym MEWPS), commonly called aerial lifts, include an extensible structure mounted onto a carrying chassis being self-propelled or not, to ensure height positioning of a working platform acting as a working station for one or more people to perform a task at a height, for example to carry out paint or repair jobs on a building facade. The extensible structure is for example formed by one or more hinged and/or telescopic arms.

An aerial lift includes a control console or station, positioned on the platform, enabling the entire aerial lift, the displacement of the chassis with respect to the ground, the deployment of the extensible structure and its rotational displacement with respect to the chassis about a vertical axis at the same time, to be controlled. Existing control consoles implement one or more joysticks and/or switches.

An aerial lift can include more than one control station. It is generally equipped with an auxiliary control station accessible from the ground which comprises control elements to bring back the platform to the ground if necessary, for example if the user located in the platform is incapable of using the control station of the platform. The auxiliary control station generally includes means for locking the aerial lift, such as a key switch and a control station selector which exclusively determines which of the control stations is active and controls the displacements of the machine. In the following of the application, the control station designates the control station on the platform. When it is the auxiliary control station, this will be set out.

The aerial lifts are generally used in job site zones.

The control station of an aerial lift is not positioned inside a cabin but is positioned on the open platform and is directly exposed to the working environment of users.

In a known manner, the user determines the state of the aerial lift based on sound information and visual information.

As regards sound information, it can be provided that the control station emits sound signals, such as beeps to signal a particular state of the aerial lift, but they can turn out to be difficult to distinguish from the other noises from the job site and the other machines which are being used.

As regards visual information, the user can make a direct visual control of the aerial lift or a control through a screen. The user may not necessarily have a full vision of the aerial lift. It can be provided to switch on indicating lamps, but these can be made poorly readable by the light environment, in particular in full sunlight and by degradations caused by soils.

On the other hand, the aerial lifts are used by people in view of performing jobs, these are not aerial lift operators. Moreover, the aerial lifts can be used by people used to using them, but also by beginners or people using them quite occasionally. It is thus desirable that the messages sent to the user are readily interpretable.

### DISCLOSURE OF THE INVENTION

Consequently, a purpose of the present invention is to offer a system including a control station and a controlled device, of a simple and intuitive use and capable of communicating with the user efficiently and surely.

The controlled device can be of different types. For example, it can be an aerial lift, a crane, a power shovel, a crane truck, a warehouse . . . a robotic arm for example in a nuclear power plant enclosure, a drone.

In one embodiment, the control station is integral with the controlled device, for example a control station of an aerial lift. In another embodiment, the control station is not integral with the controlled device and can be located remote from the device to be controlled, for example a control station of a drone, wherein the control station can be portable.

The aforementioned purpose is achieved by a system including a control station and a controlled device, said control station including at least one haptic interface with at least one degree of freedom provided with an effector, for controlling at least one action of the controlled device and a controller sending commands to the haptic interface as a function of the state of the controlled device, its position in space, and contextual data, in order to transmit detectable and understandable messages to the user, from suitable and contextualised haptic feedbacks.

The controller can also take actuation parameters of the interface into account, such as the position of the effector and/or the speed of displacement of the effector.

The control station thus appeals at least partly the user at least partly haptically and not only in a visual and/or auditive manner. The messages transmitted by the interface are identifiable because they are distinguished from ambient sounds, in particular those existing on a job site, and they do not have the drawbacks of the light signals set out above. The stimulation of the haptic senses enables the user's visual attention and auditive attention not to be further overloaded.

Very advantageously, the interface can generate at least one kinaesthetic stimulation and at least one vibrotactile stimulation, depending on the type of message to be transmitted.

For example, the interface is of the joystick type with two degrees of freedom. The kinaesthetic stimulations are advantageously generated by magnetorheological means.

The controller drives the haptic effects within the context of an aerial lift handling.

By virtue of the invention, an alternative modality of personal information not used today in the field of aerial lifts is used. The haptic language has the purpose on the one hand to solve incomprehension situations by providing information, for example by alerting the user that the deadman pedal has not been actuated, thus explaining why there is no movement, and on the other hand to reduce the situations at risk, for example when the boundaries of the safety work envelope of the aerial lift have been reached.

Further, since the interface is programmable, the haptic patterns can be readily modified and adjusted. It is thereby possible to provide several operating modes as a function of the users profiles, for example the controller can include a program for controlling the haptic interface suitable for a beginner or an occasional user, and a program suitable for a skilled user.

Thereby, the subject-matter of the present invention is a system including a control station and a device controlled by said control station, said control station including at least one control device for controlling at least one action of the controlled device, said control device comprising a haptic interface comprising at least one user interaction element, and a controller configured to send commands to the haptic interface to generate haptic stimulations at the user interaction element based at least on information relating to a state of the controlled device and/or its environment, said haptic interface includes means for generating a kinaesthetic stimulation, the system also including means for measuring the relative orientation of the user interaction element and at least one part of the controlled device, and the controller being configured such that, based on the information provided by the means for measuring the relative orientation between the control device and the controlled device, it controls the means for generating a kinaesthetic stimulation such that the control device is only displaceable along a direction parallel to the direction of displacement of said at least one part of the controlled device.

The means for measuring the relative orientation between the user interaction element and the at least one part of the controlled device can measure the relative position of the user interaction element and at least one part of the controlled device. The controller can link the direction and sense of the user interaction element and the sense of displacement of the at least one part of the controlled device.

The means for measuring the relative orientation between the user interaction element and the at least one part of the controlled device include for example at least one sensor providing an orientation piece of information of the user interaction element, and at least one sensor providing an orientation piece of information of said at least one controlled part.

The haptic interface advantageously includes means for generating a kinaesthetic stimulation. The controller can be configured to take at least the position of the user interaction element and/or means for generating a vibrotactile stimulation into account.

For example, the means for generating a kinaesthetic stimulation include at least one magnetorheological brake and the means for generating a vibrotactile stimulation include at least one vibrating actuator. The vibrating actuator is preferably positioned on the user interaction element.

The control station can include other control devices including a haptic interface or not.

Another subject-matter of the present invention is an aerial lift including a chassis, a turret hinged to the chassis, said turret comprising an extensible structure and a platform carried by the extensible structure and at least one control station according to the invention disposed on the platform.

The system advantageously includes means for detecting the state of said aerial lift and/or its arrangement with respect to the external environment and means for transmitting the signals emitted by the detection means to the controller such that it takes these signals into account to control the haptic interface.

The controlled device can include a chassis and at least one hinged structure, a platform carried by the hinged structure and at least one control station according to the invention disposed on the platform. The detection means include means for measuring the superelevation of the chassis, and/or one or more sensors for detecting the configuration of the hinged structure, and/or one or more position sensors of the hinged structure with respect to the chassis, and/or one or more load sensors and/or one or more obstacle sensors.

The controller can include charts on a safety work envelope of said controlled device and/or on at least one boundary between at least two position zones of the hinged structure.

The controlled device can be an aerial lift.

Another subject-matter of the present invention is a method for operating a system according to the invention, including the steps of:

a) measuring the relative orientation between the user interaction element and at least one part of the controlled device,

b) taking said relative orientation measured in step a) into account by the controller,

c) sending command to the haptic stimulation means,

d) generating a kinaesthetic stimulation at the user interaction element, such that the user interaction element is only displaceable along a direction parallel to the direction of displacement of the at least one part of the controlled device.

For example, during step a), the controller takes the position of the user interaction element into account.

In an operating mode in which the interaction element includes a rest position and is able to be displaced at least along a given direction from the rest position in a first sense and in a second sense opposite to the first sense, the controller can send commands to the haptic stimulation means to generate a first haptic stimulation during the displacement of the user interaction element in the first sense and a second haptic stimulation during the displacement of the user interaction element in the second sense, the first and second haptic stimulations being different.

During a compliant operation of the controlled device, said controller can send commands to the kinaesthetic stimulation means to apply a resisting strain to the user interaction element, as long as it is not sufficiently displaced to cause an action of the controlled device, and to simulate notches when the displacement of the user interaction element causes an action of the controlled device.

In one embodiment in which the controlled device includes a chassis and at least one hinged structure, a platform carried by the hinged structure:
the controller determines a safety work envelope of the controlled device and/or the presence of obstacles,
beyond a given configuration of said platform with respect to the safety work envelope of the platform and/or the presence of obstacles, said controller sends commands to the haptic stimulation means to generate at least one haptic stimulation to alert the user.

The haptic stimulation advantageously includes a kinaesthetic stimulation forcing the user to apply a further strain to the interaction element and a vibrotactile stimulation.

The controller can send a command to simulate a stop for the interaction element, when the safety work envelope is reached and/or when at least one of the actuating cylinders of the aerial structure is at stroke end.

The controller can take at least one piece of information relating to the state of the controlled device and/or its environment into account, a haptic stimulation being generated by taking account of said piece of information.

The controller can determine at least one boundary between at least two deployment zones of the hinged structure, and sends commands to the means for generating a haptic stimulation to send a haptic message to the user to inform him/her that said at least one boundary is close or crossed.

Another subject-matter of the present invention is a method for operating an aerial lift according to the invention, including the steps of:
taking at least one piece of information relating to a state of said aerial lift and/or its environment into account by the controller,
sending command to the haptic stimulation means,
generating a haptic stimulation at the user interaction element.

According to one additional characteristic, during a compliant operation of the aerial lift, the controller can send commands to the kinaesthetic stimulation means to apply a resisting strain to the user interaction element as long as it is not sufficiently displaced to cause an action of the aerial lift, and to simulate notches when the displacement of the user interaction element causes an action of the aerial lift.

According to another additional characteristic, the controller can determine a safety work envelope of the aerial lift and/or the presence of obstacles,
beyond a given configuration of said platform with respect to the safety work envelope of the platform and/or the presence of obstacles, said controller sends commands to the haptic stimulation means to generate at least one haptic stimulation to alert the user. Preferably, the haptic stimulation includes a kinaesthetic stimulation forcing the user to apply a further strain to the interaction element and a vibrotactile stimulation.

### BRIEF DESCRIPTION OF THE DRAWINGS

The present invention will be better understood based on the description that follows and the appended drawings in which:

FIG. 1 is a schematic representation of an aerial lift to which the invention is applicable,

FIG. 2 is a perspective view of an exemplary control station according to the invention,

FIGS. 3A and 3B are perspective representations of an exemplary embodiment of a haptic interface that can be implemented in the control station of FIG. 2,

FIGS. 4A and 4B are detail views of FIG. 3A, the knob being represented in a cutaway view in FIG. 3B,

FIG. 5 is a graphical representation of a haptic pattern adapted to transmit a compliant operation message for the aerial lift,

FIG. 6 is a graphical representation of a haptic pattern adapted to transmit a message that the aerial lift approaches the safety work envelope,

FIG. 7 is a graphical representation of a haptic pattern adapted to transmit a message of a hazardous situation,

FIG. 8 is a graphical representation of a haptic pattern adapted to transmit a message of an improper procedure.

### DETAILED DISCLOSURE OF PARTICULAR EMBODIMENTS

In the description that follows, the invention is mainly described in an application to an aerial lift but that is in no way limiting, since the invention can be applicable to any controlled or driven device, also designated as “remotely operated vehicle”, as for example cranes, power shovels, crane trucks, overhead cranes located for example in a plant, in a warehouse or outdoors as on harbours, robotic arms for example in a nuclear power plant enclosure, drones. This list is not limiting.

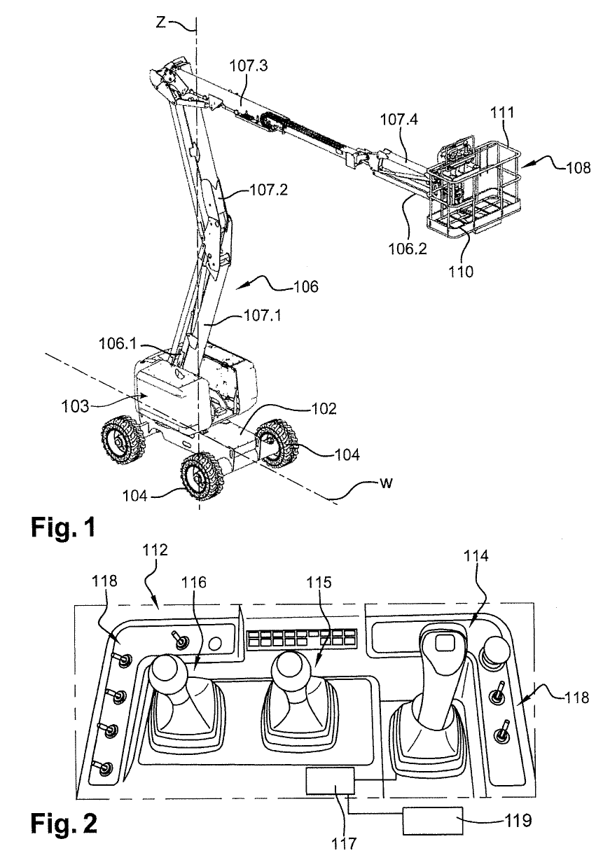

In FIG. 1, an exemplary aerial lift including a chassis 102 mounted on four wheels 104 can be seen. The chassis can be self-propelled or not. In the case where it is self-propelled, it includes for example means for driving the wheels provided with a combustion engine or an electric motor, so as to enable the aerial lift to be displaced.

The aerial lift includes an extensible structure 106 integral through one end 106.1 to the chassis 102 and provided at another end 106.2 with a platform 108. The platform 108 is for accommodating human beings, it includes a deck 110 and a guardrail 111.

The extensible structure 106 can be of different types, it can include several hinged and/or telescopic arms or be of the scissor type. It can also have vertical masts or any other hinged system.

In the example represented, the extensible structure 106 includes 4 hinged arms 107.1, 107.2, 107.3, 107.4. The lift is integral with the arm 107.4 such that its deck remains in the horizontal position whatever the relative position of the hinged arms. In this example, the arm 107.3 is further telescopic.

The displacement of the arms with respect to each other is for example achieved by means of hydraulic or electric cylinders.

In the example represented, the extensible structure 106 is mounted on a turret 103 rotatably displaceable with respect to the chassis 102 about a vertical axis Z.

The aerial lift also includes a control station or control console 112 positioned on the platform and from which the user will control the platform position in space.

In FIG. 2, a schematic representation of a platform control station can be seen. In the non-limiting example represented, the control station includes three joystick type control devices 114, 115, 116 and switch type control devices 118.

The control station and its control devices enable, among other things, the displacement of the chassis on the ground, the deployment of the extensible structure 106 and the rotation of the turret 103 about the axis Z to be controlled.

The control station 112 according to the invention includes at least one haptic interface. In the example represented, the control device 114 is a haptic interface. The other control devices are of known types. But it will be understood that the control station according to the invention can include several haptic control devices with one or two degrees of freedom, or even only haptic control devices with one or two degrees of freedom.

In the present application, by “haptic interface” it is designated any device including a user interaction element or effector for being handled by the user to transmit orders to a system, means able to send to the user haptic stimulations through the effector as a function of, for example, the position of the effector and external information, and a controller controlling the haptic stimulation means as a function of the effector position and the information for example provided by sensors or charts recorded about the operating conditions of the aerial lift.

The controller is designated by reference 117.

The sensors providing information about the platform state and contextual information are generally designated by reference 119. It can be by way of non-limiting example, one or more superelevation angle sensors, one or more obstacle sensors, cylinder stroke end sensors, sensors for the turret angular position with respect to the chassis.

The tactile stimulations include in particular kinaesthetic stimulations which are related to the movements and vibrotactile stimulations which are generated by vibrations.

The kinaesthetic stimulations are for example generated by a resisting strain (passive haptic interface) or a motive strain (active haptic interface). Preferentially, a passive haptic interface is implemented for the kinaesthetic stimulation because this interface type is secure for the user. Indeed, it can oppose a very significant strain from the user but it cannot in any case generate on its own an effector displacement not controlled by the user.

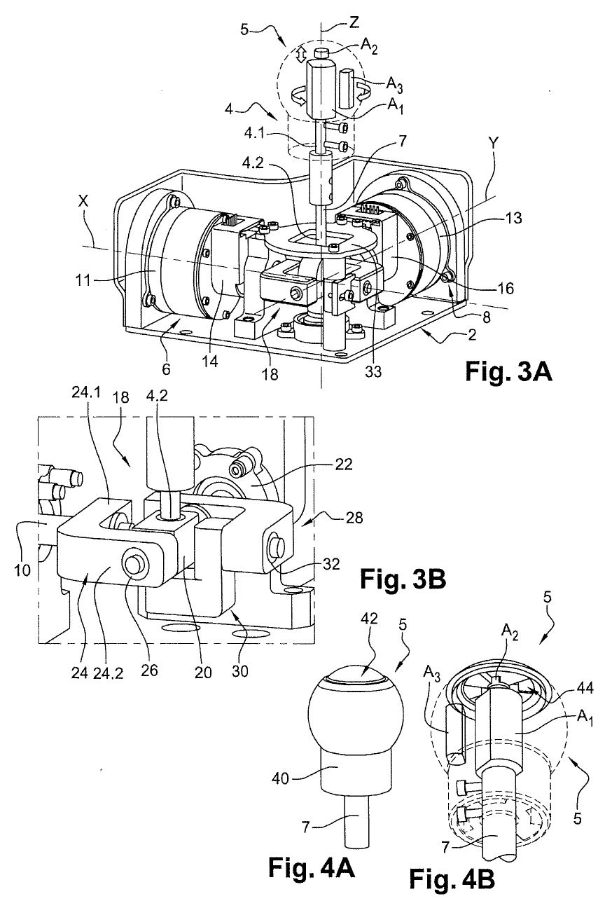

In FIGS. 3A and 3B, an exemplary haptic interface with two degrees of freedom that can be implemented in the control station according to the invention can be seen. It will be understood that this example is in no way limiting as will be described in the following of the description.

The haptic interface includes a framework 2, a user interaction element 4 hinged to the framework 2 and two magnetorheological brakes 6, 8, designated brakes in the following of the description. The magnetorheological brakes are able to generate kinaesthetic stimulations.

The interaction element 4 is in the form of a handle and will be designated handle or effector in the following of the description.

The handle 4 extends in a rest position along a longitudinal axis Z substantially perpendicular to the plane of the framework 2 and includes a first longitudinal end 4.1 for being grasped by the operator's hand and equipped for example with a knob 5 and a second longitudinal end 4.2 mechanically connected to the brakes. The knob is mounted on a rod 7 including the second longitudinal end 4.2.

In the example represented, the brake 6 is oriented along an axis X and the brake 8 is oriented along an axis Y perpendicular to the axis X and both perpendicular to the axis Z. The axes X and Y define a plane parallel to the plane of the framework. The brake 6 includes a shaft 10 (FIG. 3B) extending along the axis X and the brake 8 includes a shaft (not visible) extending along the axis Y.

In the example represented, both brakes 6 and 8 have similar structures, only the brake 6 will be described in detail. It will be understood that a haptic interface including brakes with different structures does not depart from the scope of the present invention.

An exemplary brake is for example in document WO2016050717 (it is the application BD15296). The brake 6 includes a shaft 10 rotatably displaceable about the axis X and mounted in a case. The shaft 10 includes an end mechanically connected to the second end 4.2 of the handle 4 and a second end (not visible) interacting with a magnetorheological fluid. The second end of the shaft is for example rotatably integral with a skirt disposed in a chamber filled with magnetorheological fluid. The brake also includes means for generating a magnetic field in the chamber so as to cause a modification in the magnetorheological fluid viscosity. When the viscosity increases, a resisting torque is applied to the skirt and to the shaft 10, and hence to the handle via the mechanical connection between the shaft 10 and the handle 4.

The interface includes at least one handle position sensor.

In the example represented, angular position sensors 14 and 16 measure the angular position of the shafts of the brakes 6, 8. These can for example be incremental optical coders.

The mechanical connection 18 between the handle 4 and the shafts is a system with cardan joints well known to those skilled in the art a non-limiting example of which is represented in FIG. 1.

In the example represented, the second end 4.2 of the handle 4 is mounted in a piece 20 by means of a sliding pivot 22. The shaft 10 is connected to the piece 20 by a L-shaped piece 24, a branch 24.1 of the L being rotatably integral with the shaft 10 and the other branch 24.2 of the L being hinged to the piece 20 by a sliding pivot 26.

The shaft of the brake 8 is connected to the piece 20 via two L-shaped pieces 28, 30. The two L-shaped pieces 28, 30 are hinged to each other by a sliding pivot 32, the L-shaped piece 28 is rotatably integral with the shaft of the brake 8 and the L-shaped piece 30 is rotatably integral with the piece 20.

The interface includes stops to limit the displacement in the plane X and Y of the handle, in the example represented, the stops are formed by a frame 33 disposed about the handle above the hinge with cardan joints.

Advantageously, the interface includes means for returning to the rest position, i.e. the handle is coaxial with the axis Z. These means are for example of the magnetic type disposed between the framework 2 and the hinge with cardan joints. These can for example be two permanent magnets facing each other and aligned with the axis Z and exerting a magnetic return force.

Hence, the handle can be displaced about both axes X and Y and the brakes 6, 8 are able to apply resisting torques about its axes as a function of the handle position.

On the one hand, any other hinge between the handle and the brakes enabling an interface with at least two degrees of freedom to be made falls within the scope of the present invention, as that described for example in document Bin Liu. Development of 2d haptic devices working with magnetorheological fluids. Master's thesis, University of Wollongong, Australia, 2006 or in document A. Milecki, P. Bachman, and M. Chciuk. Control of a small robot by haptic joystick with magnetorheological fluid. Mechatron. Syst. Mater.-MSM, 7, 2011.

On the other hand, the structure of the brakes could be different. Instead of a skirt, for example a disk, could interact with the magnetorheological fluid. Besides, the brake could be of the electrorheological or electromagnetic type.

Moreover, the axes of the brakes may not be perpendicular. Further, the interface could include more than two brakes.

Alternatively and as has been already mentioned, an active brake including an electric motor acting on the effector could be contemplated.

A haptic interface in which the effector would have a form other than a handle does not depart from the scope of the present invention.

Further in the example represented, the haptic interface includes one or more vibrating actuators able to generate vibrations and cause a user's vibrotactile stimulation.

In FIGS. 4A and 4B, a detail view of the knob of the haptic interface represented in FIG. 1A can be seen. In this example, the interface includes three vibrating actuators A1, A2, A3 which are mounted to the handle, for example in the knob. In one advantageous embodiment, each actuator is such that it is able to generate vibrations in a frequency range and/or an amplitude range at least partly different from those of the other two actuators. Thus, the actuators cover together a wide frequency and/or amplitude spectrum, which offers large possibilities in terms of vibrotactile sensation.

These actuators are distinct from the brakes, in particular in the case of an active brake.

The relative arrangement of the vibrating actuators is only given by way of example and is in no way limiting.

Very advantageously, the actuators are attached to the effector so as to mechanically isolate them from each other, which enables the stimulation they generate to be isolated and, for example, hand's zones to be separately excited.

According to an exemplary embodiment, the means for generating a kinaesthetic stimulation are able to generate a vibrotactile stimulation, for example by using one or more electric motors. However, this example has the drawback of having a higher electric consumption, because the entire interface mechanical hinge must be vibrated. Further, the vibrations are not generated as close as possible to the user's hand. The actuators can be disposed in any way with respect to the handle surface. Preferably, they can be disposed such that the vibrations generated are in a normal plane or a plane tangential to the skin surface.

The control station according to the invention, and in particular the haptic control device 114, enable, on the one hand, by displacing the effector, one or more functions of the aerial lift to be controlled, for example in a non-limiting way its displacement with respect to the ground, and/or the deployment of the extensible structure 106 and/or the rotation of the extensible structure 106 with respect to the chassis 102. On the other hand, it enables information or messages to be sent to the user through kinaesthetic stimulations and/or vibrotactile stimulations controlled by the controller 117 in order, for example, to alert the user about a potentially hazardous situation, to indicate that an operation is stopped, to give information about the state of the aerial lift and/or its environment.

By using the kinaesthetic stimulations or vibrotactile stimulations or, advantageously, both stimulation types successively or simultaneously, the messages sent are marked by the user unlike the sound and visual stimulations which are poorly efficient. Further, they are understandable at least to the greatest number of people.

Exemplary messages that can be sent by the haptic interface to the user in different situations will now be described. It will be understood that those are not limiting and that, for the same situations, other haptic stimulations or combinations of haptic stimulations can be generated, for example of a function of users for using the aerial lift, for example as a function of the regions of the world. Further, since the haptic interface is programmable and capable of reproducing any type of haptic pattern, any other message in the form of one or more haptic stimulations relating to another situation can be produced.

The examples of messages that will be described are mostly combinations of kinaesthetic and vibrotactile stimulations which afford a high comprehension level for the user. But, it will be understood that messages only including one or more kinaesthetic stimulations and/or one or more vibrotactile stimulations do not depart from the scope of the present invention. Further, in the examples described below, the interface represented in FIG. 2A is considered, the kinaesthetic stimulation is achieved by magnetorheological brakes generating a resisting strain onto the effector. It will be understood that the kinaesthetic stimulations can be generated by electrorheological brakes, electric motors. . . .

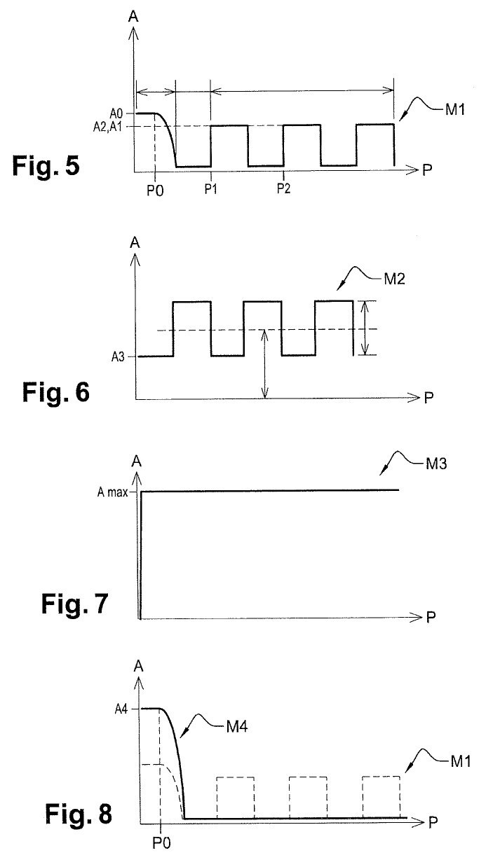

In the case of a compliant operation of the aerial lift, it can be chosen not to send any vibrotactile message, i.e. the vibrating actuator(s) is (are) not actuated. A kinaesthetic message can be sent, for example according to the haptic pattern M1 represented in FIG. 5 representing the amplitude A of the resisting strain as a function of the position P of the effector.

The case where the effector is displaced along the axis X or along the axis Y is considered.

The haptic pattern M1 is such that it generates a resisting strain with a first amplitude AO while the effector remains in a central zone and does not exceed the position P0. This strain simulates a plateau and represents the neutral zone of the effector, i.e. as long as the effector does not exit this zone, no order is sent to the aerial lift.

When the effector is displaced beyond the central zone and exceeds the position P0, a notching is foreseen to be simulated. Notches are simulated when it reaches the positions P1, P2 . . . by generating a resisting strain with the amplitude A1, A2 . . . respectively.

It can advantageously be foreseen that when the user brings back the effector to the central position, the notching haptic pattern is cancelled and the user does not feel the return stiffness of the effector.

For example, in the case where the displacement of the effector is used to regulate the speed of displacement of the aerial lift with respect to the ground, the different patterns between the displacement away from the central zone and the displacement closer to the central zone enable the user to know by a haptic feeling, whether his/her gesture produces an acceleration movement or a deceleration movement.

In the case where the displacement of the effector causes the rotation of the turret 103 with respect to the chassis 102, the displacement of the effector from the central zone in a first given sense along the direction X or Y, causes the rotation of the turret 103 in a given sense of rotation and the more distant the effector from the central zone, the quicker the rotation. To cause the rotation of the turret 103 in the opposite sense of rotation, the effector brings back the effector into the central zone and then displaces the effector in the same direction in a second sense opposite to the first sense away from the central zone. This procedure type can be applied to the forward or backward displacement of the chassis with respect to the ground and to the different movements of the extensible structure 106, such as lifting, lowering, extension or retraction of the telescopic arm 107.3, etc.

Different haptic patterns can be generated depending on whether the turret 103 is displaced in a sense of rotation or in the other and/or the chassis displaces forwardly or backwardly and depending on the displacement type of the extensible structure 106.

In the example of the haptic pattern M1, the simulation of notches is achieved by applying a rectangular shaped amplitude variation, but other shapes can be applied such as a trapezoidal, sinusoidal shape, etc. In the examples, the amplitudes A1, A2 . . . are of the same value but it could be foreseen for example that their value is increasing as the effector displaces away from the position P0, or reversely that it is decreasing. Further, the spatial frequency of the zones of notches can be different, the occurrence of notches being possibly spatially displaced closer or away or, on a certain zone, displaced closer and on a certain zone, displaced away.

Further, any other haptic texture significant to the user can be contemplated.

Finally, in the particular case of an interface with two degrees of freedom, it can be contemplated that the patterns on the axes X and Y are identical or different.

By virtue of the invention, a great number of different messages can be generated to be understandable by the user and close to the current situation.

The aerial lifts are characterised in particular by the existence of a safety work envelope which corresponds to the spatial boundary about the aerial lifts, beyond which the overturning risk increases. For example, the full deployment of the extensible structure with a particular orientation with respect to the chassis and/or a superelevation value, etc. can cause a overturning. Thus, it is desired to inform the user when the aerial lift displaces closer to this safety work envelope.

By virtue of the present invention, an alert message can be transmitted to the operator via the effector and efficiently alert the user.

The controller 117 includes for example in memory one or more charts enabling the safety work envelope of the aerial lift to be determined as a function of different parameters, such as the superelevation of the chassis of the aerial lift, the state of the extensible structure (deployment level, load onboard in the platform . . . ). The values of these parameters can be given by sensors with which the aerial lift is equipped, for example one or more chassis angle sensors.

The calculator thus calculates the safety work envelope of the aerial lift within the context in which the aerial lift is.

A threshold which is programmable upstream of the safety work envelope is recorded and one or more haptic messages is (are) transmitted to the user when the programmable threshold has been exceeded.

Depending on the orders given by the user by handling the effector of the haptic interface, the controller will control the magnetorheological brake(s) and/or the vibrating actuators to alert the user that he/she has exceeded the programmable threshold and displaces closer to the safety work envelope. The user is then informed about the possible overturning risks. Further, this alert message avoids or at least reduces the risk of misunderstanding from the user when the actuation of the aerial lift is blocked, for example when the cylinders are securely blocked or when the safety work envelope is reached.

In FIG. 6, an exemplary haptic pattern M2 enabling a kinaesthetic stimulation to be generated can be seen such that, whereas the user can still displace the effector, he/she has to exert a further unusual strain to displace it. It is reflected at the haptic pattern of FIG. 6 by notches such as those of FIG. 5, since it is a compliant operation but a continuous strain component with the amplitude A3 is superimposed with the amplitude required to cross the notches. The user has to provide an unusually high strain to displace the effector, then he/she is warned that he/she displaces closer to the safety work envelope and that the current movement can result in a situation at risk. This stimulation thereby sends a message readily interpretable by the user.

When the aerial lift reaches the safety work envelope, it can be advantageously foreseen that the brakes simulate a blocking stop, by applying a strain with a maximum amplitude AMax which prevents any further displacement of the effector in the sense aiming at maintaining danger. The haptic pattern M3 of such a stop is represented in FIG. 7. The generation of this stop can occur at each user's attempt to displace the effector in a position controlling a hazardous action, such that he/she understands that the interface is no longer actuatable. As will be seen in the following, it is preferable that the vibrotactile stimulation is not generated at each user's attempt.

The generation of a stop can also advantageously be simulated by the brakes on a command from the controller when at least one of the actuators of the aerial lift, for example a cylinder for displacing one of the arms 107.1, 107.2, 107.3 and 107.4, reaches its stroke end. One or more stroke end sensors 119 are implemented at the cylinders for displacing one of the arms.

Advantageously, if the user displaces the effector so as to displace the aerial lift away from the safety work envelope, the brakes can simulate notches with a normal amplitude without a further strain component, which will be interpreted by the user that his/her action displaces the aerial lift closer to a security situation.

The user is then guided in these gestures and haptically feels what movements are to be made to bring back the aerial lift into a safe position.

Very advantageously, it is also foreseen to transmit a vibrotactile message to the user to insist on the future risk.

For example, a so-called parking aid metaphor is employed. It consists in generating vibrations, when the programmable threshold is exceeded, these vibrations having an increasing amplitude and an increasingly high occurrence frequency when the aerial lift displaces closer to the safety work envelope. When the envelope is reached, the continuous generation of vibrations analogue to the continuous beep emitted by the parking aid when the vehicle is too close to an obstacle is advantageously provided. This vibration alerts the user and prompts him/her to stop his/her action. This vibrotactile message is for example only played once in order not to overload the user's attention.

The aerial lift can be equipped with one or more sensors enabling it to detect that the chassis and/or platform and/or extensible structure displace closer to an obstacle. The haptic interface can then inform the user of the imminence of a contact with an obstacle the user could have not be seen. The kinaesthetic and vibrotactile messages can be identical or similar to those transmitted in the case where the safety work envelope gets closer or different, for example in intensity and in frequency.

For example, these messages can be transmitted when the chassis is displaced with respect to the ground and that means, such as position or obstacle sensors and a geolocation system associated with a communication protocol between machines, detect an obstacle or a hole.

For some aerial lifts, for example those that can enable very large height to be reached, deployment zones are determined. For example, a zone restricted for the displacement of a high load and an extended zone for the displacement of a low load. These zones are defined in charts.

It can be very advantageous to transmit a message to the user when the aerial lift switches from one zone to the other or when it will switch from one zone to the other. An alert message similar to that generated in the case where the safety work envelope is getting closer can be generated. A programmable threshold can also be set. It is to be noted that the load onboard the platform can be measured by one or more sensors. Therefore, the controller can determine whether it is relevant or not to inform the user that the boundary between both zones is getting closer or crossed. For example, the controller may not communicate this piece of information if the load measured in the platform is very significantly lower than the maximum load capacity.

The delimitation of these zones can be made based on other parameters, for example based on the ground slope in which the aerial lift is disposed. For example, a restricted zone can be defined when the chassis is strongly tilted, i.e. the aerial lift is in a sloped ground, and an extended zone when the chassis is substantially horizontal, i.e. the aerial lift on a flat ground.

Further, the number of zones is not limited to two. For example, a strongly restricted zone, a restricted zone and a widened zone can be defined.

As has been explained above, aerial lifts can be used by novice or occasional users, which can forget some procedures of actuation of the aerial lifts. For example, it is frequent that the aerial lifts include a start-up and handling procedure implementing a deads-man that has to be triggered prior to start-up and handling of the aerial lift.

But, forgetting this step generally causes a user's misunderstanding which concludes from the absence of reaction of the aerial lift that the same is failing whereas it is able to operate.

By virtue of the control station according to the invention, a message can be sent to the user informing him/her that the procedure is improper and prompting him/her to verify the different steps.

From a vibrotactile point of view, it is provided to simulate a message reproducing a siren, for example by alternating vibrations with two amplitude levels and two frequency levels.

From the kinaesthetic point of view, the haptic pattern M4 reproduced can be that of FIG. 8. In dotted lines, the pattern M1 with a compliant operation is represented by way of comparison. It includes, as for the compliant operation, the generation of a resisting strain with the amplitude A4 when the effector is in a central zone and, the absence of resisting strain when the effector exits the central zone, the user can then freely displace the effector and does not feel any notch, unlike the stimulation generated in case of compliant operation.

This unusual feeling thereby warns the user that he/she is in an abnormal situation.

This stimulation is preferably applied regardless of the effector's position with respect to the axes X and Y such that the abnormal procedure message is understood by the user.

It will be understood that the displacement of the effector under these conditions, does not cause any action at the aerial lift.

An improper procedure can comprise any step causing the non-operation of the aerial lift, such as:
forgetting the dead man or forgetting the reactivation of the dead man,
forgetting the engine ignition for aerial lifts with combustion engines,
forgetting the harnessin the case of machines where this forgetting causes the non-operation,
detecting an overload,
positioning the station selector located on the control auxiliary station such that the active control station is not that handled by the user.

It can be contemplated that the same haptic message is transmitted for all the improper procedures or else, that a specific haptic message is dedicated to each improper procedure.

The novice people using the control station of an aerial lift can be clumsy. Within the scope of a training, it can be interesting to alert them about the speed with which they actuate the interface, in particular during situations at risk.

By virtue of the invention, it can be foreseen to transmit a haptic message for alerting the user without preventing his/her displacement. The message has the purpose of attracting the user's attention. This message is advantageously generated by vibrotactile stimulation by producing first only once vibrations with a strong amplitude, and then vibrations with a lower amplitude over a duration of for example 1.5 s. This message reproduces the “hey hey” vocal metaphor used to draw a person's attention to an abnormal situation, the vibrations with a strong amplitude reproducing the first “hey” and the vibrations with a lower amplitude reproducing the last “hey”.

In this type of situation, the vibrotactile stimulation is sufficiently efficient on its own. But it could be contemplated to generate a kinaesthetic stimulation in order to further enhance the alert signal.

As has been already mentioned, the haptic interface implemented enables the user's gestures to be guided.

The effector of FIG. 2A can be displaced in all the directions of the plane XY. But it can be desired that the user can haptically distinguish when he/she displaces the effector on the axes X and Y or when he/she displaces it according to a transverse direction. For example, the displacement along one of the axes as the inlet and the outlet of the telescopic arm and the displacement along the other direction controls lifting or lowering of an arm. The brakes can then be controlled such that a different resisting strain is felt by the user when he/she displaces the effector only along the direction X, or only along the direction Y, and when he/she displaces the effector in a transverse direction. For example, the brakes can generate a further resisting strain when the effector is transversally displaced. Thus, the user clearly distinguishes when he/she controls both movements independently or in combination. The use of the aerial lift is easier and safer since the user haptically feels the actions he/she controls.

Furthermore, it is possible, by virtue of the haptic interface, to transmit general information messages to the user for information purpose only, on about a situation or a state which does not endanger the user or does not cause the non-operation of the control elements of the aerial lift. For example, the user can be informed about the battery level or the fuel level of the aerial lift.

For example, a message is generated by vibrotactile stimulation such that it is not intrusive. Further, it is advantageously relatively short to be able to be ignored if need be. Several vibrating actuators can be activated with different amplitudes and frequencies. Moreover, the vibrations generated can be stopped at any time. This time discontinuity between both actuators which are not stopped at the same time enables a progressive switch-off of the actuators simulating a battery effect which is emptied or a water droplet which falls down on a liquid to be enhanced. The haptic interface can for example implement a first actuator able to generate medium frequency vibrations and a second actuator able to generate low frequency vibrations. For example, the first actuator emits medium frequency vibrations the amplitude of which decreases from a high value to a low value and a second actuator emits low frequency vibrations the amplitude of which decreases but remains at high values.

The message has the advantage of having a relatively mild feeling and is differentiated from other messages for example alert messages.

The implementation of vibrotactile messages is particularly interesting to transmit information messages because their feeling does not require any action on the effector unlike kinaesthetic messages which require a displacement of the effector to be felt. It is to be noted however that these information vibrotactile messages can be transmitted while the user displaces the effector and feels on the other hand a kinaesthetic stimulation transmitting another type of message.

Further, the implementation of a control station provided with at least one haptic interface enables the station use to be improved.

It can be foreseen that the controller makes the displacement of the effector more difficult, for example in the case of a displacement on a rough broken land, in order to limit the transmission to the effector of shocks caused by ground unevennesses and avoid brusque variations in the movement control. The information of the ground state can be provided either by sensors, for example by angle sensors on the chassis, either by the user which will for example actuate a button indicating that the land is rough broken, either by the position sensor(s) of the effector making it possible to determine that the displacement of the effector is too quick.

The effector actuation is thereby made safer and more precise.

By virtue of the invention, it can also be foreseen to modify the resisting strains applied to the effector in case of a risk of crushing the operator. For example, it can happen that the user is projected against the control station by an obstacle external to the platform and comes to bear against the interface effector. In order to reduce the injury risk, the controller, for example based on information provided by the displacement of a security bar as described in patent FR3007401, controls the brakes such that they apply no resisting strain to the effector. The latter can thereby be easily displaced, in particular be pushed back against the bracket by offering low resistance. Thus, the risks of perforating the user's body by the effector can be reduced.

The chassis of an aerial lift can be displaced frontwardly to rearwardly and reversely along a longitudinal direction W. Generally, the control of the forward and rearward displacement movement of the chassis is made by displacing an effector along a single axis, frontwardly and rearwardly. On an aerial lift equipped with a turret 103, the angular position of the platform 111 and the control console 112 with respect to the chassis 102 ranges from 0° to 360°. This results in that the direction of displacement of the effector is parallel to the direction W of displacement of the aerial lift and the rearward displacement of the effector actually corresponds to a displacement of the aerial lift rearwardly and the frontward displacement of the effector actually corresponds to a frontward displacement of the aerial lift, when the angle between the chassis and the turret is 0°. The same problem can a rise in the case of a hydraulic shovel or a mobile crane.

Consequently, the frontward/rearward direction of displacement of the effector which controls the chassis displacement has an orientation and possibly a sense different from the rearward/backward direction of the chassis as soon as the turret has pivoted with respect to the chassis. It is confusing for the operator who can erroneously control a movement in one direction and one sense different from those he/she desired. But, an error in the direction or sense of displacement of the aerial lift can cause hazardous situations, the aerial lift can collide with a wall whereas the user wished to move away from it.

By virtue of the fully programmable haptic interface implemented in the control station according to the invention, the controller can reprogram the relationship between direction and sense of displacement of the effector and direction and sense of displacement of the chassis for example based on information provided on the angular position between the platform and the chassis. For that, the controller can control the brakes 6 and 7 to enable the actuator to be displaced only along a single direction which is parallel to the direction W of the chassis and block the displacement of the actuator along all the other directions. Thus, the user does not have to take account of the displacement of the platform with respect to the chassis any longer and does not have to modify his/her behaviour during the effector actuation to displace the chassis on the ground. The use security of the aerial lift is thereby substantially improved.

More generally, means for measuring the orientation of the control station are provided, in particular that of the effector(s), with respect to that of the controlled device. This piece information thereby enables the controller to adapt the degree(s) of freedom of the effector in order to ensure a safe control. For example, the means measure the relative orientation between the control station carried by the operator on foot and the controlled device.

In one exemplary embodiment, the means for measuring the orientation include a compass carried by the control station and a compass carried by the controlled device. The compasses can be mechanical or electronic, for example they can be magnetometers.

In another exemplary embodiment, the means for measuring the orientation are of the radioguiding type, the device including for example an emitter of waves having a given form and the control station including a receiver capable of analysing the wave received and of determining the relative orientation of the control station and the controlled device.

In another example, the means for measuring the orientation are for example optical means, for example with a pattern recognition feature.

In another exemplary embodiment, the control station enables an air drone to be controlled. Based on the orientation information of the drone with respect to the control station obtained for example using electronic compass type sensors, the control station can favour or prohibit displacement directions of the drone by programming different haptic strains which are felt during the displacement of the control station effector. For example, drones offering overflight capacities (quadri-rotor type drone, helicopter) induce the possibility of changing the orientation of the vehicle on the flight, whereas the control station located on the ground can remain fixed. Further, the drone can be equipped with an obstacle detection device (ultrasound, laser, radar telemetric device), the haptic interface of the control station can alert the user of a danger or possible collision, or prohibit a displacement which would place the drone in a hazard situation, for example a displacement which would cause the drone to get closer to a wall, a tree, a pylon etc. Finally, the control station can also haptically restore information about the drone environment, for example the direction and/or wind force. This information can be reflected in a vibrotactile stimulation with a variable intensity and/or frequency, by haptic notches felt when the effector is displaced in a direction causing the displacement of the drone into the wind, or by any other haptic message.

Advantageously, the controller can send commands to the haptic stimulation means to generate different haptic stimulations along the sense of displacement of the effector, in order to inform the user about a sense of displacement of the lift which is controlled. For example, different notches can be simulated depending on the sense of displacement, or notches can be simulated in one sense of displacement and no simulation may be provided in the other sense of displacement.

The haptic interface can be programmed to allow a step of selecting an action and then an order of this action. For example, a resisting strain is applied to the effector such that it is displaceable only along an axis in one sense or in the other, to select an action. The action selected depends on the sense of displacement of the effector. A haptic message, for example, a vibrotactile message, is sent to indicate to the user that the selection has been made. Then, the brakes are activated such that the effector is displaceable along the other direction only to control the selected action.

For example, a scissor type aerial lift can be considered. The control sequence is:

1) during a first step, the effector is in a “selector” mode, it can only be displaced along the axis X to the left or to the right. A displacement to the left selects the translation action of the chassis, and a displacement to the right selects the lifting action. When the selection is made, vibrations on a short duration are emitted, confirming the selection,

2) during a second step, the effector is only displaceable along the direction Y, by pushing the effector, it carries out a proportional control. For example, by pushing the effector forwardly or rearwardly, the user controls the movement selected proportionally.

The control station according to the invention provides messages detectable and recognisable by the user, because they appeal to the sense of touch which is not appealed to, unlike sight and hearing. Further, kinaesthetic stimulations and vibrotactile stimulations used separately or in combination enable haptic messages readily understandable by the user to be created.

Moreover, by advantageously coupling vibrating actuators and brakes, the advantages of both types of kinaesthetic and vibrotactile haptic feedbacks are combined, which enables all the situations to be covered complementarily by different feedbacks. The brakes allow a rich and stable feedback upon actuating the interface and the vibrating actuators allow a vibrotactile feedback drivable on demand even if the effector is not displaced.

Hence, it is possible to transmit messages to the user, both when he/she does not displace the effector and when he/she displaces the effector, for example to inform of a cylinder stroke end or reaching the boundary of the safety work envelope of the aerial lift after the effector has reached its maximum displacement position.

The vibrotactile stimulation can also be particularly efficient when a more disruptive or intensive feedback as the case of alerts has to be applied, this type of feedback is more hardly implementable with the resisting coupling on its own. The vibrotactile stimulation for example enables a feedback on demand to be provided, as a function of the time elapsed and/or application context events, for example a non-ignited engine and/or as a function of the position and/or speed of displacement of the effector.

Further, since the haptic interface is programmable, it offers a great freedom for haptic stimulations that can be generated. Further, it can be programmed to offer functionalities other than the transmission of haptic messages, such as taking account of the platform rotation with respect to the chassis upon controlling the frontward-backward displacements.

In the description above, the haptic interface has two degrees of freedom, but a haptic interface having a single degree of freedom does not depart from the scope of the present invention. For example, the effector could be only displaced along a forward-backward direction and reversely, or from left to right and reversely. Further, a control station including more than one haptic interface, or even not including haptic interfaces does not depart from the scope of the present invention.

Finally, the invention is applicable to all the control stations, for example both the control station on the platform and the auxiliary control station, of all the types of aerial lifts, whatever the type of extensible structure, whatever the means for actuating the extensible structure, and whatever the means for displacing the platform. Further, the controller of the interface can be connected to different detection means equipping the platform such as accelerometers, angle sensors, position sensor, geolocation system, load detector. It can also communicate with other machines. Thus, the controller can receive information about the environment of the platform and its change over time and emit contextual messages.

1-22. (canceled)

23. A system comprising at least one control station and a device controlled by said control station, said control station including at least one control device for controlling at least one action of the controlled device, said control device comprising a haptic interface comprising at least one user interaction element, and a controller configured to send commands to the haptic stimulation interface to generate haptic stimulations at the user interaction element based at least on information relating to a state of the controlled device and/or its environment, said haptic interface includes a kinaesthetic stimulation generator for generating a kinaesthetic stimulation, wherein the system also includes at least one sensor for measuring the relative orientation of the user interaction element and at least one part of the controlled device, and wherein the controller is configured such that, based on the information provided by at least one sensor for measuring the relative orientation between the control device and the controlled device, the controller controls the kinaesthetic stimulation generator such that the control device is only displaceable along a direction parallel to the direction of displacement of said at least one part of the controlled device.

24. The system according to claim 23, wherein at least one sensor measuring the relative orientation between the user interaction element and at least one part of the controlled device measure the relative position of the user interaction element and at least one part of the controlled device, and wherein the controller links the direction and sense of the user interaction element and the sense of displacement of at least one part of the controlled device.

25. The system according to claim 23, wherein at least one sensor for measuring the relative orientation between the user interaction element and at least one part of the controlled device comprises at least one sensor providing an orientation piece of information of the user interaction element, and at least one sensor providing an orientation piece of information of said at least one controlled part.

26. The control system according to claim 23, wherein the controller is configured to take at least the position of the user interaction element into account.

27. The system according to claim 23, wherein the kinaesthetic stimulation generator includes at least one magnetorheological brake.

28. The system according to claim 23, wherein the haptic stimulation interface includes a generator for generating a vibrotactile stimulation.

29. The system according to claim 28, wherein generator for generating a vibrotactile stimulation includes at least one vibrating actuator.

30. The system according to claim 29, wherein at least one vibrating actuator is positioned on the user interaction element.

31. The system according to claim 23, including other control devices including a haptic stimulation interface or not.

32. The system according to claim 23, including a detector for detecting the state of the controlled device and/or its arrangement with respect to the external environment and a transmitter for transmitting the signals emitted by the detector to the controller such that it takes the signals into account to control the haptic interface.

33. The system according to claim 23, wherein the controlled device includes a chassis and at least one hinged structure, a platform carried by at least one hinged structure and at least one control station being disposed on the platform, and wherein the detector includes a sensor for measuring the superelevation of the chassis, and/or one or more sensors for detecting the configuration of at least one hinged structure, and/or one or more position sensors of at least hinged structure with respect to the chassis, and/or one or more load sensors and/or one or more obstacle sensors.

34. The system according to claim 33, wherein the controller includes charts on a safety work envelope of said controlled device and/or on at least one boundary between at least two position zones of the hinged structure.

35. The system according to claim 23, wherein the controlled device is an aerial lift.

36. A method for operating a system according to claim 23, including the steps of:
a) measuring the relative orientation between the user interaction element and at least one part of the controlled device,
b) taking said relative orientation measured in step a) into account by the controller,
c) sending command to the haptic stimulation interface,
d) generating a kinaesthetic stimulation at the user interaction element, such that the user interaction element is only displaceable along a direction parallel to the direction of displacement of at least one part of the controlled device.

37. The method according to claim 36, wherein during step a), the controller takes the position of the user interaction element into account.

38. The method according to claim 37, the interaction element including a rest position and being able to be displaced at least along a given direction from the rest position in a first sense and in a second sense opposite to the first sense, and wherein the controller sends commands to the haptic stimulation interface to generate a first haptic stimulation, during the displacement of the user interaction element in the first sense, and a second haptic stimulation during the displacement of the user interaction element in the second sense, the first and second haptic stimulations being different.

39. The method according to claim 36, wherein, during a compliant operation of the controlled device, said controller sends commands to the kinaesthetic stimulation generator to apply a resisting strain to the user interaction element, as long as it is not sufficiently displaced to cause an action of the controlled device, and to simulate notches when the displacement of the user interaction element causes an action of the controlled device.

40. The method according to claim 36, wherein the controlled device includes a chassis and at least one hinged structure, a platform carried by the hinged structure:
the controller determines a safety work envelope of the controlled device and/or the presence of obstacles,
beyond a given configuration of said platform with respect to the safety work envelope of the platform and/or the presence of obstacles, said controller sends commands to the haptic stimulation interface to generate at least one haptic stimulation to alert the user.

41. The method according to claim 40, wherein the haptic stimulation includes a kinaesthetic stimulation forcing the user to apply a further strain to the interaction element and a vibrotactile stimulation.

42. The method according to claim 40, wherein the controller sends a command to simulate a stop for the interaction element, when the safety work envelope is reached and/or when at least one of the actuating cylinders of the aerial structure is at stroke end.

43. The method according to claim 36, wherein the controller takes account of at least one piece of information relating to the state of the controlled device and/or its environment, a haptic stimulation being generated by taking account of said piece of information.

44. The method according to claim 40, wherein the controller takes account of at least one piece of information relating to the state of the controlled device and/or its environment, a haptic stimulation being generated by taking account of said piece of information, and wherein the controller determines at least one boundary between at least two deployment zones of the hinged structure, and sends commands to the haptic stimulation interface to send a haptic message to the user to inform him/her that said at least one boundary is close or crossed.
